(19) United States
(12) Patent Application Publication
(10) Pub. No.: US 2017/0286947 A1
(43) Pub. Date: Oct. 5, 2017

(54) Contactless Smart-card Reader with Security and Hybrid Multi-core Parallel Verifying Process

(71) Applicant: Baoruh Electronic Co., Ltd., Kaohsiung (TW)

(72) Inventor: Pao-Lang Chung, Kaohsiung (TW)

(21) Appl. No.: 15/455,189

(22) Filed: Mar. 10, 2017

(30) Foreign Application Priority Data
Mar. 30, 2016 (TW) 105110175

(51) Int. Cl. G06Q 20/34; G06K 19/07; H04L 29/06; G06K 7/00; G07F 7/08

(52) U.S. Cl. CPC G06Q 20/352; G06K 7/0004; G07F 7/0813; G07F 7/0893; H04L 63/0853; G06Q 20/341; G06K 7/0013; G06K 19/0723

(57) ABSTRACT

A contactless smart-card reader with security and hybrid multi-core parallel verifying process is provided. The reader obtains a card number via an antenna and a card-recognizing unit. The reader has multiple issuer-SAM controllers and a maincontroller to synchronously compute authentication codes under a multiplexing-mode. The maincontroller verifies the contactless smart-card by the authentication codes one-by-one to obtain a correct authentication code authorized by the contactless smart-card. When the correct authentication code is generated by any one of the issuer-SAM controllers, said issuer-SAM controller performs the compounded-security-access-software program. When the correct authentication code is generated by the maincontroller, the maincontroller performs the dedicated-security-access-software program.

### CROSS-REFERENCE TO RELATED APPLICATIONS

This application claims the benefit of Taiwan patent application No. 105110175, filed on Mar. 30, 2016, the disclosure of which is incorporated herein in its entirety by reference.

### BACKGROUND OF THE INVENTION

### 1. Field of the Invention

The present invention relates to a contactless smart-card reader, and more particularly to a contactless smart-card reader with security and hybrid multi-core parallel verifying process.

### 2. Description of Related Art

With development of electronic commerce technology, applications of contactless smart-cards (such as chip-cards) are gradually integrated into daily life. A store would have a contactless card reader comprising a security access module (hereinafter referred to as SAM) and a controller. The SAM stores security verification data provided by an electronic payment service provider (hereinafter referred to as provider) or a ticketing network operator (hereinafter referred to as operator). When a contactless smart-card enters a wireless detecting range of the contactless card reader, the controller computes an authentication code according to the security verification data and a card number of the contactless smart-card to verify the contactless smart-card. When the card verification is completed, the contactless card reader performs an access-software program to exchange data, access data, exchange key (authentication code), or perform other verifying mechanisms with the contactless smart-card to complete a transaction. Hence, a consumer can pay for purchases or services by a contactless smart-card, instead of cash. It is convenient for the consumer.

However, different providers or different operators may have different security-access-software programs. Hence, different providers or different operators provide their contactless card readers to stores for the use of the contactless smart-cards. As a result, different contactless card readers belong to different providers or different operators are incompatible. One store has to install many contactless card readers belonging to different providers or different operators for the consumers that carry different contactless smart-cards. The contactless card readers in one store may take up much space. Moreover, if a consumer places a contactless smart-card on a wrong contactless card reader, the transaction would fail. The consumer has to move the contactless smart-card to be placed a correct contactless card reader. Such movements for the consumer may waste time and annoys the consumer.

### SUMMARY OF THE INVENTION

An objective of the present invention is to provide a contactless smart-card reader with security and hybrid multi-core parallel verifying process. The contactless smart-card reader may be comprehensively applicable for different providers or operators with different requirements.

The contactless smart-card reader of the present invention comprises an antenna, a card-recognizing unit, multiple SAMs (Security Access Modules), multiple issuer-SAM (Security Access Module) controllers, and a maincontroller.

The antenna is adapted to sense a contactless smart-card.

The card-recognizing unit is connected to the antenna to read a card number of the contactless smart-card.

The multiple SAMs respectively correspond to different electronic payment service providers or ticketing network operators.

Each one of the issuer-SAM controllers is connected to at least two SAMs of the multiple SAMs, stores a compounded-security-access-software program corresponding to the at least two SAMs connected to each one of the multiple issuer-SAM controllers, and generates multiple first authentication codes according to the card number and the at least two SAMs.

The maincontroller has multiple I/O (input/output) pins respectively connected to the card-recognizing unit, the multiple issuer-SAM controllers, and at least one SAM of the multiple SAMs directly and stores a dedicated-security-access-software program corresponding to the at least one SAM connected to the maincontroller.

The at least one SAM connected to the maincontroller is distinct from the at least two SAMs connected to each one of the multiple issuer-SAM controllers. The maincontroller generates at least one second authentication code according to the card number and the at least one SAM connected to the maincontroller. The maincontroller simultaneously transmits the card number to the multiple issuer-SAM controllers under a multiplexing-mode and obtains the multiple first authentication codes from the multiple issuer-SAM controllers. The multiple issuer-SAM controllers and the maincontroller synchronously compute the first authentication codes and the at least one second authentication code under the multiplexing-mode. The maincontroller verifies the contactless smart-card by the first authentication codes and the at least one second authentication code one-by-one to obtain a correct authentication code authorized by the contactless smart-card. The correct authentication code is generated by any one of the multiple issuer-SAM controllers or the maincontroller.

When the correct authentication code is generated by any one of the issuer-SAM controllers, said issuer-SAM controller performs the compounded-security-access-software program. When the correct authentication code is generated by the maincontroller, the maincontroller performs the dedicated-security-access-software program. The at least one SAM connected to the maincontroller is a single SAM, and the dedicated-security-access-software program is an exclusive-security-access-software program.

Based on the contactless smart-card reader of the present invention, the multiple SAMs respectively correspond to different electronic payment service providers (hereinafter referred to as providers) or ticketing network operators (hereinafter referred to as operators). Hence, the present invention may integrate software programs of multiple providers or operators. The contactless smart-card reader is adapted to be applied to different contactless smart-cards of the providers or operators to exchange data, access data, exchange keys, or perform other verifying mechanisms with the contactless smart-card.

Compared with the conventional art, for a store manager, the store manager may just use the contactless smart-card reader of the present invention without taking up too much space. For a consumer, the consumer just puts any contactless smart-card on the reader without having to distinguish the provider or operator. The convenience of use is promoted.

The multiple issuer-SAM controllers and the maincontroller synchronously compute the first authentication codes and the at least one second authentication code under the multiplexing-mode. Hence, regardless of the number of the SAMs connected to the issuer-SAM controllers and the maincontroller, the issuer-SAM controllers and the maincontroller may rapidly compute the authentication codes in a short time (such as 0.5 seconds) and complete a transaction.

The contactless smart-card reader of the present invention has advantage of high processing speed. Adding SAMs for new providers or operators may not slow down the verifying speed of the present invention.

The issuer-SAM controllers and the maincontroller are independently configured. The compounded-security-access-software programs stored in the issuer-SAM controllers and the dedicated-security-access-software program stored in the maincontroller are dedicated and distinct from each other. When the compounded-security-access-software program stored in any one of the issuer-SAM controllers is changed, the compounded-security-access-software programs stored in other issuer-SAM controllers and the dedicated-security-access-software program stored in the maincontroller would not be affected. Hence, the compounded-security-access-software programs and the dedicated-security-access-software program have features of independence and security.

The providers and the operators may have different market sizes and different market mechanisms. For example, some providers or operators may belong to a same parent company or cooperate in association. The providers or operators may share one issuer-SAM controller for accessing the SAMs to mutually manage a mechanism of the security key (authentication code) of the contactless smart-card.

An exclusive dedicated issuer-SAM controller is necessary to access the SAMs for some companies that would like to have top class security for the mechanism of the security key of the contactless smart-card. On the contrary, some companies, considering the cost of the contactless smart-card reader, would like to have lower class of security for the mechanism of the security key of the contactless smart-card, may share one issuer-SAM controller, instead of using the exclusive dedicated issuer-SAM controller.

Therefore, the contactless smart-card reader of the present invention meets the requirements of market sizes and market mechanisms of the providers and the operators.

### BRIEF DESCRIPTION OF THE DRAWINGS

FIG. 1 is a block diagram of an embodiment of the contactless smart-card reader of the present invention.

### DETAILED DESCRIPTION OF THE PREFERRED EMBODIMENT

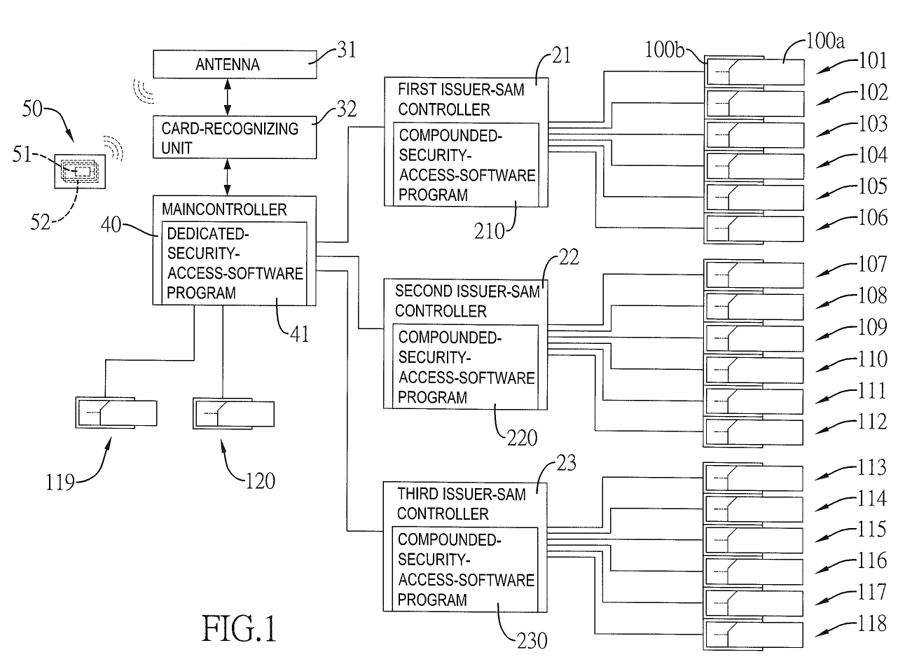

FIG. 1 discloses a block diagram of an embodiment of the contactless smart-card reader of the present invention. The contactless smart-card reader comprises multiple SAMs (Security Access Modules) 101-120, multiple issuer-SAM (Security Access Module) controllers 21-23, an antenna 31, a card-recognizing unit 32, and a maincontroller 40.

The multiple SAMs 101-120 may respectively correspond to different electronic payment service providers (hereinafter referred to as providers) or ticketing network operators (hereinafter referred to as operators). Each SAM 101-120 is electrically connected to a security-access card 100a provided by a provider or a operator. The security-access card 100a stores security verification data provided by the provider or the operator. In an embodiment, each SAM 101-120 may comprise a socket 100b. The security-access card 100a is adapted to be inserted into the socket 100b and electrically connected to the SAM. In another embodiment, the security verification data may be written to each SAM 101-120, such that each SAM 101-120 may store the security verification data. Different providers or different operators may have different security verification data.

Each issuer-SAM controller 21-23 is connected to at least two SAMs of the multiple SAMs 101-120 to form a one-to-many (“one issuer-SAM controller” to “multiple SAMs”) configuration. Different issuer-SAM controllers are electrically connected to different SAMs. In other words, any one of the SAMs is electrically connected to only one of the issuer-SAM controllers, rather than more than one of the issuer-SAM controllers. Each issuer-SAM controller stores a compounded-security-access-software program 210, 220, 230. The compounded-security-access-software program is programmable. The compounded-security-access-software program is compounded by multiple exclusive-security-access-software programs provided by the providers or the operators that correspond to the at least two SAMs connected to the corresponding issuer-SAM controller. In other words, each provider or the operator has its own exclusive-security-access-software program that is distinct from other exclusive-security-access-software programs. Each provider or the operators has its own exclusive-security-access-software program. The present invention has the exclusive-security-access-software program to exchange data, access data, exchange keys (such as authentication code), or perform other verifying mechanisms with a contactless smart-card 50, such as a chip-card, that belongs to such provider or operator. Since the compounded-security-access-software program 210, 220, 230 is compounded from multiple different exclusive-security-access-software programs, the contactless smart-card reader of the present invention may exchange data, access data, exchange keys, or perform other verifying mechanisms with the contactless smart-card 50 that belongs to different providers or operators.

The antenna 31 is adapted to generate or sense electromagnetic waves and has a wireless detecting range. The card-recognizing unit 32 is electrically connected to the antenna 31. In an embodiment, the card-recognizing unit 32 may be a radio-frequency control chip for card accessing.

The maincontroller 40 has multiple I/O (input/output) pins respectively connected to the card-recognizing unit 32 and the issuer-SAM controllers 21-23. The maincontroller 40 may be connected to at least one SAM of the SAMs 101-120 directly. The at least one SAM connected to the maincontroller 40 is distinct from the SAMs connected to the issuer-SAM controllers 21-23. The maincontroller 40 and the issuer-SAM controllers 21-23 are not connected to a same SAM. The maincontroller 40 stores a dedicated-security-access-software program 41 corresponding to the at least one SAM connected to the maincontroller 40. Besides, for the issuer-SAM controllers 21-23, the maincontroller 40 operates as an arbiter for performing intermediate arbitration and resource allocation. When the at least one SAM connected to the maincontroller 40 is a single SAM, the dedicated-security-access-software program 41 is an exclusive-security-access-software program. When the at least one SAM connected to the maincontroller 40 comprises multiple SAMs, the dedicated-security-access-software program 41 is a compounded-security-access-software program that is compounded by different exclusive-security-access-software programs.

For further applications, the maincontroller 40 may have a communication interface for data transmission with external electronic payment systems or ticketing operators.

As shown in FIG. 1, the embodiment comprises twenty SAMs 101-120 including sequentially a first SAM 101, a second SAM 102, a third SAM 103, . . . , and a twentieth SAM 120. The embodiment has three issuer-SAM controllers 21-23 including a first issuer-SAM controller 21, a second issuer-SAM controller 22, and a third issuer-SAM controller 23. The first issuer-SAM controller 21 is electrically connected to the first to the sixth SAMs 101-106. The second issuer-SAM controller 22 is electrically connected to the seventh to the twelfth SAMs 107-112. The third issuer-SAM controller 23 is electrically connected to the thirteenth to the eighteenth SAMs 113-118. The maincontroller 40 is directly connected to the nineteenth SAM 119 and the twentieth SAM 120.

In general, a contactless smart-card 50 comprises a chip 51 and an antenna 52. When the contactless smart-card 50 enters the wireless detecting range of the antenna 31, the contactless smart-card 50 communicates with the contactless smart-card reader of the present invention via the antenna 52 and the antenna 31, such that the card-recognizing unit 32 may read a card number of the contactless smart-card 50. When the card-recognizing unit 32 obtains the card number of the contactless smart-card 50, the card-recognizing unit 32 transmits the card number to the maincontroller 40. When the maincontroller 40 obtains the card number, the maincontroller 40 simultaneously transmits the card number to the multiple issuer-SAM controllers 21-23 under the multiplexing-mode. Besides, the maincontroller 40 receives the security verification data from the nineteenth SAM 119 and the twentieth SAM 120.

When the issuer-SAM controllers 21-23 receive the card number, the issuer-SAM controllers 21-23 synchronously operate. The first issuer-SAM controller 21 generates six first authentication codes according to the card number and the security verification data stored in the first to the sixth SAMs 101-106 respectively. Similarly, the second issuer-SAM controller 22 generates another six first authentication codes according to the card number and the security verification data stored in the seventh to the twelfth SAMs 107-112 respectively. The third issuer-SAM controller 23 generates another six first authentication codes according to the card number and the security verification data stored in the thirteenth to the eighteenth SAMs 113-118 respectively. Meanwhile, the maincontroller 40 generates two second authentication codes according to the card number and the security verification data stored in the nineteenth to the twentieth SAMs 119-120 respectively. Therefore, the multiple issuer-SAM controllers 21-23 and the maincontroller 40 synchronously compute the first authentication codes and the at least one second authentication code under the multiplexing-mode.

As a result, the maincontroller 40 obtains twenty authentication codes including the eighteen first authentication codes and the two second authentication codes. The maincontroller 40 verifies the contactless smart-card 50 by the twenty authentication codes. In detail, the maincontroller 40 transmits the twenty authentication codes one-by-one to the contactless smart-card 50 via the antenna 31. Accordingly, the chip 51 of the contactless smart-card 50 examines the validity of the authentication codes one-by-one and transmits a verifying result to the maincontroller 40. When any one of the authentication codes is authorized as a correct authentication code, the maincontroller 40 may obtain the verifying result indicating the correct authentication code. The correct authentication code is generated by any one of the multiple issuer-SAM controllers 21-23 or the maincontroller 40. When the correct authentication code is generated by any one of the issuer-SAM controllers, said issuer-SAM controller performs the compounded-security-access-software program. When the correct authentication code is generated by the maincontroller 40, the maincontroller 40 performs the dedicated-security-access-software program 41.

Afterwards, the maincontroller 40 may confirm that the correct authentication code corresponds to any one of the providers and the operators. The correct authentication code is regarded as a unique security key to access the contactless smart-card 50. The unique security key stands for an access authorization of the contactless smart-card 50.

For example, when the correct authentication code is generated by any one of the issuer-SAM controllers 21-23, such as the second issuer-SAM controller 22, the second issuer-SAM controller 22 performs its compounded-security-access-software program to exchange data, access data, exchange keys, or perform other verifying mechanisms with the contactless smart-card 50 via the maincontroller 40 to complete a transaction. On the other hand, when the correct authentication code is generated by the maincontroller 40, the maincontroller 40 performs its dedicated-security-access-software program to directly exchange data, access data, exchange keys, or perform other verifying mechanisms with the contactless smart-card 50 to complete a transaction.

In conclusion, the present invention has an advantage of rapid processing to obtain the authentication codes of the SAMs 101-120 in the shortest time. The maincontroller 40 verifies the contactless smart-card 50 by the authentication codes one-by-one to obtain a correct authentication code. Based on the correct authentication code, the contactless smart-card reader of the present invention may exchange data, access data, exchange keys, or perform other verifying mechanisms with the contactless smart-card 50. In addition, one issuer-SAM controller corresponds to multiple SAMs. The present invention may obtain the authentication codes from the SAMs 101-120 under a condition that the number of the issuer-SAM controllers 21-23 and the maincontroller 40 is less than the number of the SAMs 101-120, such that the cost for the issuer-SAM controllers 21-23 may be economized.

The compounded-security-access-software programs stored in the issuer-SAM controllers and the dedicated-security-access-software program 41 stored in the maincontroller 40 are dedicated and distinct from each other. For example, a change to the compounded-security-access-software program 210 stored in the first issuer-SAM controllers 21 does not affect the compounded-security-access-software program 220, 230 stored in the second issuer-SAM controllers 22 and the third issuer-SAM controllers 22 and the dedicated-security-access-software program 41 stored in the maincontroller 40.

If some providers or operators belong to a same parent company or have cooperative relationships (i.e. having business contracts, joining in a group, or joining in a league), any one of the providers or operators may be entrusted to make the compounded-security-access-software program. Such compounded-security-access-software program would be stored in any one of the issuer-SAM controllers 21-23. In an embodiment, the compounded-security-access-software program is stored in the third issuer-SAM controllers 23 as an example. When any one of the providers or operators corresponding to the thirteenth to the eighteenth SAMs 113-118 would update its exclusive-security-access-software program, the compounded-security-access-software program may be directly amended to update that exclusive-security-access-software program. Based on the cooperative relationships, other providers or operators corresponding to the thirteenth to the eighteenth SAMs 113-118 would not be worried about security issues that the verifying mechanism may be leaked. Hence, the contactless smart-card reader of the present invention has features of independence and security.

What is claimed is:

1. A contactless smart-card reader with security and hybrid multi-core parallel verifying process, comprising:
an antenna adapted to sense a contactless smart-card;
a card-recognizing unit connected to the antenna to read a card number of the contactless smart-card;
multiple SAMs (Security Access Modules) respectively corresponding to different electronic payment service providers or ticketing network operators;
multiple issuer-SAM (Security Access Module) controllers, wherein each one of the issuer-SAM controllers is connected to at least two SAMs of the multiple SAMs, stores a compounded-security-access-software program corresponding to the at least two SAMs connected to each one of the multiple issuer-SAM controllers, and generates multiple first authentication codes according to the card number and the at least two SAMs; and
a maincontroller having multiple I/O (input/output) pins respectively connected to the card-recognizing unit, the multiple issuer-SAM controllers, and at least one SAM of the multiple SAMs directly and storing a dedicated-security-access-software program corresponding to the at least one SAM connected to the maincontroller;
wherein the at least one SAM connected to the maincontroller is distinct from the at least two SAMs connected to each one of the multiple issuer-SAM controllers;
wherein the maincontroller generates at least one second authentication code according to the card number and the at least one SAM connected to the maincontroller;
wherein the maincontroller simultaneously transmits the card number to the multiple issuer-SAM controllers under a multiplexing-mode and obtains the multiple first authentication codes from the multiple issuer-SAM controllers;
wherein the multiple issuer-SAM controllers and the maincontroller synchronously compute the first authentication codes and the at least one second authentication code under the multiplexing-mode;
wherein the maincontroller verifies the contactless smart-card by the first authentication codes and the at least one second authentication code one-by-one to obtain a correct authentication code authorized by the contactless smart-card;
wherein the correct authentication code is generated by any one of the multiple issuer-SAM controllers or the maincontroller;
wherein when the correct authentication code is generated by any one of the issuer-SAM controllers, said issuer-SAM controller performs the compounded-security-access-software program;
wherein when the correct authentication code is generated by the maincontroller, the maincontroller performs the dedicated-security-access-software program;
wherein the at least one SAM connected to the maincontroller is a single SAM, and the dedicated-security-access-software program is an exclusive-security-access-software program.

2. The contactless smart-card reader as claimed in claim 1, wherein
each one of the SAMs comprises a socket for a security-access card to be inserted into the socket and electrically connected to the SAM.

3. The contactless smart-card reader as claimed in claim 1, wherein each one of the SAMs stores security verification data.

4. A contactless smart-card reader with security and hybrid multi-core parallel verifying process, comprising:
an antenna adapted to sense a contactless smart-card;
a card-recognizing unit connected to the antenna to read a card number of the contactless smart-card;
multiple SAMs (Security Access Modules) respectively corresponding to different electronic payment service providers or ticketing network operators;
multiple issuer-SAM (Security Access Module) controllers, wherein each one of the issuer-SAM controllers is connected to at least two SAMs of the multiple SAMs, stores a compounded-security-access-software program corresponding to the at least two SAMs connected to each one of the multiple issuer-SAM controllers, and generates multiple first authentication codes according to the card number and the at least two SAMs; and
a maincontroller having multiple I/O (input/output) pins respectively connected to the card-recognizing unit, the multiple issuer-SAM controllers, and at least one SAM of the multiple SAMs directly and storing a dedicated-security-access-software program corresponding to the at least one SAM connected to the maincontroller;
wherein the at least one SAM connected to the maincontroller is distinct from the at least two SAMs connected to each one of the multiple issuer-SAM controllers;
wherein the maincontroller generates at least one second authentication code according to the card number and the at least one SAM connected to the maincontroller;
wherein the maincontroller simultaneously transmits the card number to the multiple issuer-SAM controllers under a multiplexing-mode and obtains the multiple first authentication codes from the multiple issuer-SAM controllers;
wherein the multiple issuer-SAM controllers and the maincontroller synchronously compute the first authentication codes and the at least one second authentication code under the multiplexing-mode;
wherein the maincontroller verifies the contactless smart-card by the first authentication codes and the at least one second authentication code one-by-one to obtain a correct authentication code authorized by the contactless smart-card;
wherein the correct authentication code is generated by any one of the multiple issuer-SAM controllers or the maincontroller;
wherein when the correct authentication code is generated by any one of the issuer-SAM controllers, said issuer-SAM controller performs the compounded-security-access-software program;
wherein when the correct authentication code is generated by the maincontroller, the maincontroller performs the dedicated-security-access-software program;
wherein the at least one SAM connected to the maincontroller comprises multiple SAMs, and the dedicated-security-access-software program is a compounded-security-access-software program.

5. The contactless smart-card reader as claimed in claim 4, wherein
each one of the SAMs comprises a socket for a security-access card to be inserted into the socket and electrically connected to the SAM.

6. The contactless smart-card reader as claimed in claim 4, wherein each one of the SAMs stores security verification data.
